(19) United States
(12) Patent Application Publication
(10) Pub. No.: US 2024/0400047 A1
(43) Pub. Date: Dec. 5, 2024

(54) TWO-STATE BOUNDED CLOSED-LOOP CONTROL OF ACTUATORS

(71) Applicant: Hyliion Inc., Cedar Park, TX (US)

(72) Inventors: Kristopher Jason Healey, Waterford, MI (US); Brian Ba Huynh, Austin, TX (US)

(21) Appl. No.: 18/325,238

(22) Filed: May 30, 2023

(51) Int. Cl. B60W 30/14; B60W 10/20; B60W 30/12; B60W 40/105; B60W 50/00

(52) U.S. Cl. CPC B60W 30/14; B60W 10/20; B60W 30/12; B60W 40/105; B60W 50/00; B60W 2050/0005; B60W 2050/0011; B60W 2510/0604; B60W 2510/0657

(57) ABSTRACT

A computer-implemented method executed using a computer that is communicatively coupled to an actuator comprises, in one embodiment: obtaining, from electronic memory coupled to the computer, a target setpoint value, upper bound value, lower bound value, and proximity value; continuously measuring, using the actuator, a current value of a metric associated with the actuator; in response to determining, based on the proximity value, that the current value is near the upper bound value or that a rate of approach of the current value to the upper bound value is greater than an approach threshold, signaling the actuator to cause a reduction of the metric; in response to determining, based on the proximity value, that the current value is near the lower bound value or that a rate of approach of the current value to the lower bound value is greater than an approach threshold, signaling the actuator to cause an increase in the metric.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2022-2023 Hyliion Inc.

### TECHNICAL FIELD

One technical field of the present disclosure is closed-loop control circuits for actuators, such as closed-loop proportional-integral-derivative (PID) controls. Other technical fields include automatic and/or predictive cruise control and/or cooling circuits for motor vehicles and lane drift control circuits and software.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Closed-loop proportional-integral-derivative (PID) controls typically are configured to drive an actuator and measure its response to maintain a target setpoint. For example, a motor vehicle cruise control circuit and/or software can be configured as a closed-loop PID control with which an operator sets a setpoint, the control measures the then-current velocity or speed of the vehicle and determines whether the speed is less than the setpoint, then automatically increases the throttle or actuates the accelerator. Measurement is continuous and the circuit or software stops actuating the actuator when the setpoint is reached. Other kinds of closed-loop controls impose bounds on the controls using output constraints, such as minimum and maximum values that act as bounds for a final command, or by adjusting the gains of the system.

However, in some physical systems or environments, PID controls cause actuators to yield excessive costs, provide an imperfect human experience, or impose undesirable loads on mechanical components. For example, the use of PID controls for cruise control in heavy trucks traversing undulating grades can require too many changes of the gearbox or accelerator, imposing excessive load on engine components or resulting in an uncomfortable ride for a human operator.

Based on the foregoing, the referenced technical fields have developed an acute need for better ways to control actuators.

### SUMMARY

The appended claims may serve as a summary of the invention.

### BRIEF DESCRIPTION OF THE DRAWINGS

In the drawings:

FIG. 1 illustrates a distributed computer system showing the context of use and principal functional elements with which one embodiment could be implemented.

FIG. 2 illustrates an example computer-implemented process for two-state bounded closed-loop control of actuators, in one embodiment.

FIG. 3 is a graph showing an example change in vehicle velocity over time in a vehicle having velocity controlled using an embodiment.

FIG. 4 is a block diagram of circuit logic that could be used to implement one embodiment.

FIG. 5A is a graph showing an example change in vehicle drivetrain torque over time in a vehicle that is controlled using an embodiment.

FIG. 5B is a graph showing an example change in vehicle acceleration over time in a vehicle that is controlled using an embodiment.

FIG. 5C is a graph showing an example change in vehicle velocity over time in a vehicle having velocity controlled using an embodiment.

FIG. 5D is a graph showing an example change in road grade over time for the same vehicle as illustrated in FIG. 5A, FIG. 5B, FIG. 5C.

FIG. 6 illustrates a hypothetical road and aspects of vehicle lane control using an embodiment.

FIG. 7 is a block diagram that illustrates an example computer system with which an embodiment may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program the computer to implement the claimed inventions, at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

One or more different inventions may be described in this disclosure, with alternative embodiments to illustrate examples. Other embodiments may be utilized and structural, logical, software, electrical, and other changes may be made without departing from the scope of the particular inventions. Various modifications and alterations are possible and expected. Some features of one or more of the inventions may be described with reference to one or more particular embodiments or drawing figures, but such features are not limited to usage in the one or more particular embodiments or figures with reference to which they are described. Thus, the present disclosure is neither a literal description of all embodiments of one or more of the inventions nor a listing of features of one or more of the inventions that must be present in all embodiments.

Headings of sections and the title are provided for convenience but are not intended as limiting the disclosure in any way or as a basis for interpreting the claims. Devices that are described as in communication with each other need not be in continuous communication with each other unless expressly specified otherwise. In addition, devices that are in communication with each other may communicate directly or indirectly through one or more intermediaries, logical or physical.

A description of an embodiment with several components in communication with one other does not imply that all such components are required. Optional components may be described to illustrate a variety of possible embodiments and to fully illustrate one or more aspects of the inventions. Similarly, although process steps, method steps, algorithms, or the like may be described in sequential order, such processes, methods, and algorithms may generally be configured to work in different orders, unless specifically stated to the contrary. Any sequence or order of steps described in this disclosure is not a required sequence or order. The steps of described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment, but need not occur only once. Some steps may be omitted in some embodiments or some occurrences, or some steps may be executed more than once in a given embodiment or occurrence. When a single device or article is described, more than one device or article may be used in place of a single device or article. Where more than one device or article is described, a single device or article may be used in place of more than one device or article.

The functionality or features of a device may be alternatively embodied by one or more other devices that are not explicitly described as having such functionality or features. Thus, other embodiments of one or more of the inventions need not include the device itself. Techniques and mechanisms described or referenced herein will sometimes be described in singular form for clarity. However, it should be noted that particular embodiments include multiple iterations of a technique or multiple manifestations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

### 1. General Overview

In an embodiment, a computer-implemented method executed using a computer that is communicatively coupled to an actuator comprises, in one embodiment: obtaining, from electronic memory coupled to the computer, a target setpoint value, upper bound value, lower bound value, and proximity value; continuously measuring, using the actuator, a current value of a metric associated with the actuator; in response to determining, based on the proximity value, that the current value is near the upper bound value or that a rate of approach of the current value to the upper bound value is greater than an approach threshold, signaling the actuator to cause a reduction of the metric; in response to determining, based on the proximity value, that the current value is near the lower bound value or that a rate of approach of the current value to the lower bound value is greater than an approach threshold, signaling the actuator to cause an increase in the metric.

Embodiments of the disclosure encompass the subject matter of the following numbered clauses:

1. A computer-implemented method executed using a computer that is communicatively coupled to an actuator, the method comprising: obtaining, from electronic memory coupled to the computer, a target setpoint value, upper bound value, lower bound value, and proximity value; continuously measuring, using the actuator, a current value of a metric associated with the actuator; in response to determining, based on the proximity value, that the current value is near the upper bound value or that a rate of approach of the current value to the upper bound value is greater than an approach threshold, signaling the actuator to cause a reduction of the metric; and in response to determining, based on the proximity value, that the current value is near the lower bound value or that a rate of approach of the current value to the lower bound value is greater than an approach threshold, signaling the actuator to cause an increase in the metric.

2. The computer-implemented method of clause 1, wherein the actuator is a unit of an electromechanical system, the method further comprising repeating the continuously measuring, the determining, and the signaling in real-time as the electromechanical system operates.

3. The computer-implemented method of clause 1, wherein the computer is in a motor-driven land vehicle.

4. The computer-implemented method of clause 1, wherein the target setpoint value, the upper bound value, and the lower bound value comprise vehicle speed values.

5. The computer-implemented method of clause 1, wherein the actuator is a throttle of a land vehicle.

6. The computer-implemented method of clause 1, wherein the actuator is a motor controller of a land vehicle.

7. The computer-implemented method of clause 1, wherein the actuator is a torque controller of a land vehicle.

8. The computer-implemented method of clause 1, wherein each of the signaling operations comprises transmitting a signal to a command arbitration unit as a first input to the command arbitration unit, wherein the command arbitration unit comprises a second input that is coupled to a cruise control sensing and status setpoint unit, the command arbitration unit being programmed to arbitrate the first input and the second unit and to output a torque request based on arbitrating the first input and the second input.

9. The computer-implemented method of clause 1, wherein each of the signaling operations comprises transmitting a signal to a command arbitration unit as a first input to the command arbitration unit, wherein the command arbitration unit comprises a second input that is coupled to a steering control, automated steering column, steering rack, rudder, lane keeping assist system or lane centering assist system, the command arbitration unit being programmed to arbitrate the first input and the second unit and to output a steering correction request to adjust a lane position based on arbitrating the first input and the second input.

10. The computer-implemented method of clause 1, wherein each of the signaling operations comprises transmitting a signal to a command arbitration unit as a first input to the command arbitration unit, wherein the command arbitration unit comprises a second input that is coupled to a fan control, pump control, a digital thermometer, thermistor, thermostat or valve, the command arbitration unit being programmed to arbitrate the first input and the second unit and to output a cooling request to one or more of the fan control, pump control, a digital thermometer, thermistor, thermostat or valve, based on arbitrating the first input and the second input.

11. The computer-implemented method of clause 1, further comprising additionally executing a closed-loop PID control to maintain the target setpoint value via periodic actuation of the actuator and continuous measurement of a response of the actuator.

12. A hardware-based vehicle control unit comprising one or more of firmware, NVRAM, or volatile RAM storing one or more sequences of instructions which, when executed using the hardware-based vehicle control unit, causes the hardware-based vehicle control unit to execute: obtaining, from electronic memory coupled to the vehicle control unit, a target setpoint value, upper bound value, lower bound value, and proximity value; continuously measuring, using the actuator, a current value of a metric associated with the actuator; in response to determining, based on the proximity value, that the current value is near the upper bound value or that a rate of approach of the current value to the upper bound value is greater than an approach threshold, signaling the actuator to cause a reduction of the metric; and in response to determining, based on the proximity value, that the current value is near the lower bound value or that a rate of approach of the current value to the lower bound value is greater than an approach threshold, signaling the actuator to cause an increase in the metric.

13. The vehicle control unit of clause 10, wherein the actuator is a unit of an electromechanical system, the vehicle control unit being further programmed to execute: repeating the continuously measuring, the determining, and the signaling in real-time as the electromechanical system operates.

14. The vehicle control unit of clause 10, in a motor-driven land vehicle.

15. The vehicle control unit of clause 10, wherein the target setpoint value, upper bound value, and the lower bound value comprise vehicle speed values.

16. The vehicle control unit of clause 10, wherein the actuator is a throttle of a land vehicle.

17. The vehicle control unit of clause 10, wherein the actuator is a motor controller of a land vehicle.

18. The vehicle control unit of clause 10, wherein the actuator is a torque controller of a land vehicle.

19. The vehicle control unit of clause 10, wherein each of the signaling operations comprises transmitting a signal to a command arbitration unit as a first input to the command arbitration unit, wherein the command arbitration unit comprises a second input that is coupled to a cruise control sensing and status setpoint unit, the command arbitration unit being programmed to arbitrate the first input and the second unit and to output a torque request based on arbitrating the first input and the second input.

20. The vehicle control unit of clause 10, wherein each of the signaling operations comprises transmitting a signal to a command arbitration unit as a first input to the command arbitration unit, wherein the command arbitration unit comprises a second input that is coupled to a steering control, automated steering column, steering rack, rudder, lane keeping assist system or lane centering assist system, the command arbitration unit being programmed to arbitrate the first input and the second unit and to output a steering correction request to adjust a lane position based on arbitrating the first input and the second input.

21. The vehicle control unit of clause 10, wherein each of the signaling operations comprises transmitting a signal to a command arbitration unit as a first input to the command arbitration unit, wherein the command arbitration unit comprises a second input that is coupled to a fan control, pump control, a digital thermometer, thermistor, thermostat or valve, the command arbitration unit being programmed to arbitrate the first input and the second unit and to output a cooling request to one or more of the fan control, pump control, a digital thermometer, thermistor, thermostat or valve, based on arbitrating the first input and the second input.

22. The vehicle control unit of clause 10, the vehicle control unit being further programmed to execute a closed-loop PID control to maintain the target setpoint value via periodic actuation of the actuator and continuous measurement of a response of the actuator.

### 2. Structural & Functional Overview

### 2.1 Distributed Computer System Example

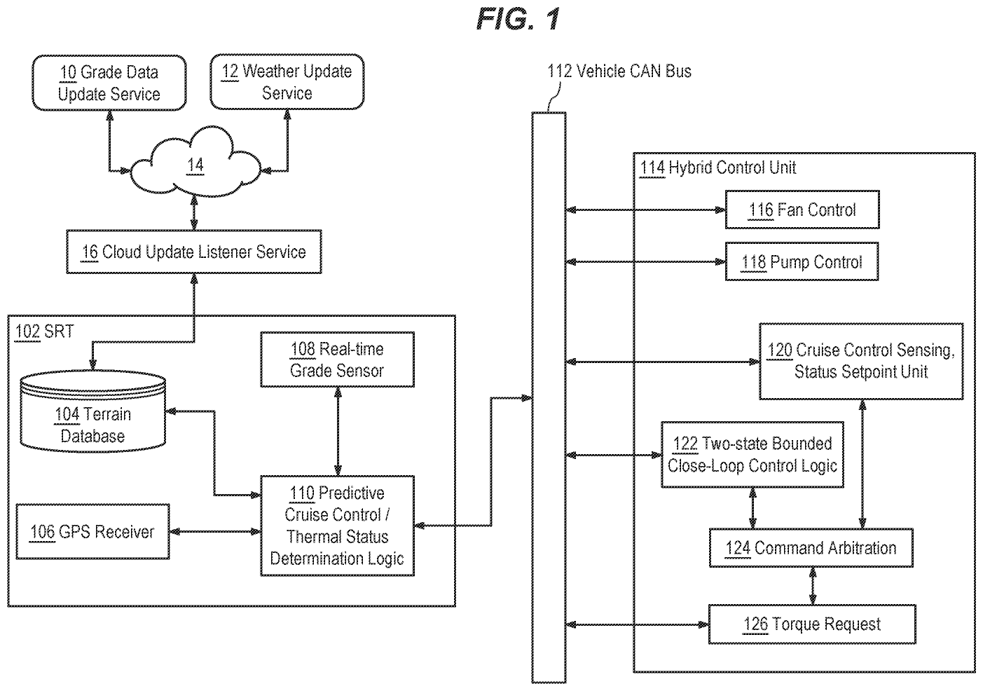

FIG. 1 illustrates a distributed computer system showing the context of use and principal functional elements with which one embodiment could be implemented. In an embodiment, the computer system comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. FIG. 1 illustrates only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose and claim a technical system and technical methods in which specially programmed computers, using a special-purpose distributed computer system design, execute functions that have not been available before to provide a practical application of computing technology to the problem of the automatic control of actuators to or near a setpoint without undesirable loads on mechanical components, excessive use of energy, excessive costs, or an uncomfortable or disruptive human experience. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

The elements of FIG. 1 are illustrated primarily to show one example physical system in which an embodiment can be used, and all elements of FIG. 1 or the arrangement of elements in FIG. 1 are not required in all embodiments. In one embodiment, a distributed computer system of FIG. 1 comprises a vehicle computer (SRT) 102 that is communicatively coupled to a vehicle controller area network (CAN) bus 112, and a hybrid control unit 114 that also is coupled to the CAN bus. These elements typically are installed in a vehicle such as a hybrid, or fully-electric truck, automobile, or another kind of vehicle.

In some embodiments, the vehicle computer 102 is communicatively coupled via a cloud update listener service 16 to a data network 14, to which a grade data update service 10 and weather update service 12 can be linked. Data network 14 broadly represents any combination of internetworks, wide area networks, local area networks, and/or campus networks using any of wired or wireless, satellite, or terrestrial links.

In an embodiment, the grade data update service 10 comprises one or more server computers, storage systems, virtual compute instances, and/or virtual storage instances that obtain, store, and transmit upon request digital data representing the locations and attributes or parameters of roads and road grades in one or more territories. For example, grade data update service 10 can comprise a networked server or virtual compute instance having access to digital data storage and/or a database that stores grade data for US interstate highways specifying the location, direction, length, incline, decline, or other parameters of a plurality of grade segments. The grade data update service 10 can be programmed with an application programming interface (API) responsive to requests, such as parameterized HTTP requests or other programmatic calls, and capable of querying the data store or database, formatting a response, and transmitting the response to a calling process. Or, the grade data update service 10 can be programmed to periodically transmit messages to a message bus, RSS feed, or other programmatic facilities, and the cloud update listener service 16 can be programmed to subscribe to the messages, feed, or facility. The cloud update listener service 16 and grade data update service 10 can be programmed to use any mutually compatible publish-subscribe (pub-sub) facility. In this manner the vehicle computer 102 can be programmed, in a manner compatible with the grade data update service 10, to periodically obtain grade data from the grade data update service 10 and to update a terrain database 104 based upon responses. In this manner, a static or moving vehicle can maintain an onboard terrain database 104 with grade data relevant to routes or roads that the vehicle may traverse.

In an embodiment, the weather update service 12 comprises one or more server computers, storage systems, virtual compute instances, and/or virtual storage instances that obtain, store, and transmit upon request digital data representing current and/or forecasted weather conditions in one or more territories. For example, weather update service 12 can comprise a networked server or virtual compute instance having access to digital data storage and/or a database that stores weather data for cities, counties, ZIP codes, or other geographical units that contain or are near roads or highways and specifying condition data such as temperature, wind direction, wind velocity, precipitation amount or intensity, or other condition or forecast attributes.

The weather update service 12 can be programmed with an application programming interface (API) responsive to requests, such as parameterized HTTP requests or other programmatic calls, and capable of querying the data store or database, formatting a response, and transmitting the response to a calling process. Or, the weather update service 12 can be programmed to periodically transmit messages to a message bus, RSS feed, or other programmatic facilities, and the cloud update listener service 16 can be programmed to subscribe to the messages, feed, or facility. The cloud update listener service 16 and weather update service 12 can be programmed to use any mutually compatible pub-sub facility. In this manner vehicle computer 102 can be programmed, in a manner compatible with the weather update service 12, to periodically obtain weather data and to update the terrain database 104 or other data storage based upon responses. In this manner, a static or moving vehicle can maintain an onboard database with weather data relevant to routes or roads that the vehicle may traverse.

In some embodiments, vehicle computer 102 further comprises a global positioning system (GPS) receiver 106, real-time grade sensor 108, and predictive cruise control/thermal status determination logic 110, which may be communicatively coupled to vehicle CAN bus 112. The GPS receiver 106 can be configured to periodically read GPS satellite signals, execute a position triangulation algorithm, and form real-time location data representing the position of the vehicle in geophysical space using, for example, a latitude-longitude pair of values. The real-time grade sensor 108 can be configured to use accelerometers, gyroscopes, or other hardware to sense the current level of incline of the vehicle. The predictive cruise control/thermal status determination logic 110 can be configured to transmit signals to CAN bus 112 to command electric motor(s) and/or fuel-fed motor(s) or generator(s) of the vehicle to increase or decrease throttle, torque, voltage, current, or other motor, engine, or generator input, supply, or operating parameters. Further, it will be appreciated that while embodiments disclosed herein are described with respect to a motor, engine, and/or generator, the computer-implemented processes and/or algorithms for a two-state bounded closed-loop control may be applicable to any motor, engine, generator, or other heat generating device or system by adapting the definition or identity of the setpoint, the actuator, and the specific means of driving the actuator according to the specific sensing means, input requirements and/or operating requirements of the motor, engine, generator, or other heat generating device or system.

Hybrid control unit 114 is configured to drive and/or control a plurality of hardware elements associated with the engine(s) or motor(s), drivetrain, cooling systems, and related systems of the vehicle. The label “hybrid” can be used in embodiments integrated with hybrid fuel-fed/electric vehicles, and other embodiments can use other labels for control units for conventional fuel-fed vehicles or non-hybrid electric vehicles. In any of these embodiments, a control unit can be used that omits one or more of the elements of hybrid control unit 114 of FIG. 1.

In one embodiment, hybrid control unit 114 comprises a fan control 116 that is configured to control a fan of a cooling system of the vehicle under stored program control. In an embodiment, hybrid control unit 114 comprises a pump control 118 that is configured to control a water pump and/or fuel pump of the vehicle engine(s) system(s).

In an embodiment, the hybrid control unit 114 further comprises a cruise control sense, status, and setpoint unit 120 that is communicatively coupled to a command arbitration unit 124, which connects to a torque request unit 126. In an embodiment, two-state bounded close-loop control logic 122 is coupled to the command arbitration unit 124. Each of the units 120, 124, 126, and logic 122, can be implemented in hardware, firmware, or software that executes using a microcontroller or microprocessor of the hybrid control unit 114, or a combination thereof. For example, the two-state bounded close-loop control logic 122 can comprise a hardware-based vehicle control unit such as an ASIC, FPGA, or microcontroller coupled to programmed firmware, NVRAM, or volatile RAM, any of which can be termed a processor, computer, or controller. The specific functions of the foregoing elements are described further in subsequent sections.

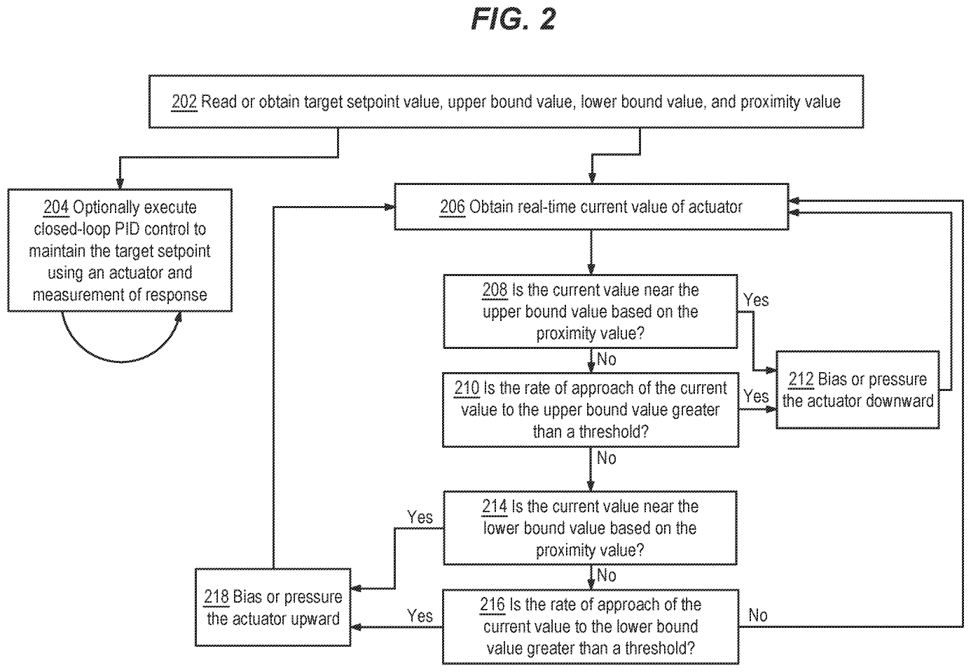

In general, the cruise control sense, status, and setpoint unit 120 is configured to receive input signals specifying a then-current vehicle speed and a setpoint representing a desired or target speed, to determine one or more first changes in torque or other vehicle parameters that are needed to change the current vehicle speed closer to the target speed, and to transmit signals or commands to the command arbitration unit 124 that represent the first changes. In an embodiment, two-state bounded close-loop control logic 122 is configured to implement the functions of FIG. 2, which can include determining one or more second changes in vehicle torque, speed, or other parameters and transmitting signals or commands to the command arbitration unit 124 that represent the second changes. The command arbitration unit 124 is configured to select from among the first changes and the second changes based on one or more programmed rules, heuristics, or decision logic, and to transmit signals or messages to the torque request unit 126, which is configured to command one or more electric motors, fuel-fed engines, fuel agnostic generators, drivetrain elements, or other components of the vehicle to implement the selected changes. Thus, as further described in other sections, the two-state bounded close-loop control logic 122 is configured to transmit a signal to the command arbitration unit 124 as a first input to the command arbitration unit, and the command arbitration unit comprises a second input that is coupled the cruise control sensing and status setpoint unit 120, the command arbitration unit being programmed to arbitrate the first input and the second unit and to output a torque request based on arbitrating the first input and the second input.

In one embodiment, the hybrid control unit 114 or another computer configured to implement the techniques herein is in a motor-driven land vehicle, and the target setpoint value, upper bound value, and lower bound value comprise vehicle speed values. In an embodiment, the actuator is any of a throttle of a land vehicle, a motor controller of a land vehicle, or a torque controller of a land vehicle. Other embodiments can be used in other environments and with other actuators.

### 2.2 Example Data Processing Flows

FIG. 2 illustrates an example computer-implemented process for two-state bounded closed-loop control of actuators, in one embodiment. FIG. 2 and each other flow diagram herein are intended as an illustration of the functional level at which skilled persons, in the art to which this disclosure pertains, communicate with one another to describe and implement algorithms using programming. The flow diagrams are not intended to illustrate every instruction, method object or sub-step that would be needed to program every aspect of a working program, but are provided at the same functional level of illustration that is normally used at the high level of skill in this art to communicate the basis of developing working programs. FIG. 2 can represent a plan for programming the two-state bounded close-loop control logic 122 of FIG. 1.

In one embodiment, at block 202, a process illustrated in FIG. 2 is programmed to read or obtain a target setpoint value, upper bound value, lower bound value, and proximity value. As the remaining description will show, in general, the target setpoint value represents a goal or target the process is configured to cause a system to approach or reach. In embodiments useful with land vehicles, the target setpoint value can be expressed in units relevant to an attribute such as vehicle velocity, speed, engine rotation speed, engine or fluid temperature values or cooling setpoints, or lane position. Other embodiments can have target setpoint values relating to or expressed in other kinds of units or parameters. The upper bound value represents the highest value that the attribute is allowed to reach before the process acts to reduce the value of the attribute. The lower bound value represents the lowest value that the attribute is allowed to reach before the process acts to increase the value of the attribute. The proximity value represents a threshold value, typically near to or proximate to the upper bound or the lower bound, at which the process begins acting to increase or decrease the value of the attribute.

At block 206, the process is programmed to obtain a real-time, current value of an actuator. Block 206 can comprise programmatically or electronically reading a then-current value of an encoder, sensor, or another hardware element, reading a specified memory address to retrieve a data value that another system wrote to the address, calling a system function, calling another program or any other means of digitally electronically determining a value of an actuator. In various embodiments, the actuator can be a vehicle speed indicator, unit 120 of FIG. 1, an engine controller or motor controller, or an electronic throttle. The specific type of actuator is not critical, provided that the actuator has some means by which the process can read a current value or status.

At block 208, the process is configured to determine if the current value obtained at block 206 is near the upper bound value, based on the proximity value. For example, the proximity value can specify an absolute value that is less than the upper bound value, or a relative value such as 5% of the upper bound value. Thus, block 208 could be configured to test whether the current value of block 206 is greater than or equal to the proximity value, or greater than or equal to a value resulting from applying the proximity value to the upper bound value using a function or calculation.

If the test of block 208 is TRUE or YES or the equivalent, then the current value is approaching the upper bound value. Consequently, control transfers to block 212 at which the process is configured to bias or pressure the actuator downward. In some embodiments, block 212 can comprise transmitting a signal or message to the actuator to reduce the magnitude of an aspect of the actuation of the actuator. For example, block 212 can cause signaling a speed reduction, torque reduction, less throttle, or other signal or message that is intended to move the current value away from the upper bound.

At block 210, the process is configured to test whether a rate of approach of the current value to the upper bound value is greater than a threshold. Block 210 can comprise inspecting multiple digitally stored values of the current value, obtained at block 206, over a recent period and calculating a rate, trend, or vector from the values, and assessing whether the rate of change of the value is greater than a threshold value that is stored, configured, or otherwise specified. If so, then control transfers to block 212, which acts as previously described. In this manner, FIG. 2 is configured to transfer control to block 212 to bias or pressure the actuator downward when the real-time, current value of the actuator is either near the upper bound value or approaching the upper bound value at greater than a specified rate of change.

After block 212, process control transfers to block 206 to obtain another real-time, current value of the actuator and repeat the process. A loop represented in the foregoing blocks and operations can continue for as long as the actuator is available or operating, or as long as the process of FIG. 2 is engaged or active. Embodiments can include means for disengaging or deactivating the process, such as software controls, hardware controls, vehicle cab or dashboard controls, or other controls.

Block 214, block 216, and block 218 represent the converse operational case. In an embodiment, at block 214, the process is configured to determine if the current value obtained at block 206 is near the lower bound value, based on the proximity value. For example, the proximity value can specify an absolute value that is greater than the lower bound value, or a relative value such as 5% of the lower bound value. Thus, block 214 could be configured to test whether the current value of block 206 is less than or equal to the proximity value, or less than or equal to a value resulting from applying the proximity value to the lower bound value using a function or calculation.

If the test of block 214 is TRUE or YES or the equivalent, then the current value is approaching the lower bound value. Consequently, control transfers to block 218 at which the process is configured to bias or pressure the actuator upward. In some embodiments, block 218 can comprise transmitting a signal or message to the actuator to increase the magnitude of an aspect of the actuation of the actuator. For example, block 218 can cause signaling a speed increase, torque increase, more throttle, or other signal or message that is intended to move the current value away from the lower bound.

At block 216, the process is configured to test whether a rate of approach of the current value to the lower bound value is greater than a threshold. Block 216 can comprise inspecting multiple digitally stored values of the current value, obtained at block 206, over a recent period and calculating a rate, trend, or vector from the values, and assessing whether the rate of change of the value is greater than a threshold value that is stored, configured, or otherwise specified. If so, then control transfers to block 218, which acts as previously described. In this manner, FIG. 2 is configured to transfer control to block 212 to bias or pressure the actuator upward when the real-time, current value of the actuator is either near the lower bound value or approaching the lower bound value at greater than a specified rate of change.

After block 218, control transfers to block 206 to obtain another real-time, current value of the actuator and repeat the process. A loop represented in the foregoing blocks and operations can continue for as long as the actuator is available or operating, or as long as the process of FIG. 2 is engaged or active. Embodiments can include means for disengaging or deactivating the process, such as software controls, hardware controls, vehicle cab or dashboard controls, or other controls.

Additionally, as shown in block 204, an embodiment can implement the option for a conventional closed-loop PID control to maintain the target setpoint using the actuator and continuous measurement of response. For example, the functions of FIG. 2 other than block 204 could be integrated with a conventional vehicle cruise control, as represented by block 204, or as implemented using the cruise control sensing, status, setpoint unit 120 of FIG. 1.

### 2.3 Operational Examples for Vehicle Embodiment(s)

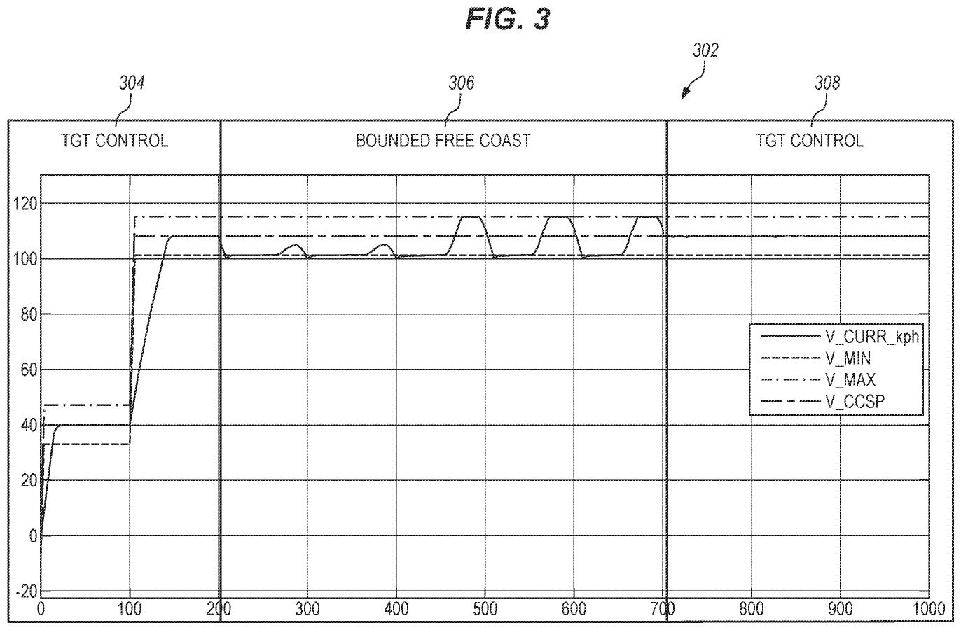

FIG. 3 is a graph showing an example change in vehicle velocity over time in a vehicle having velocity controlled using an embodiment. In FIG. 3, a graph 302 has a vertical axis that represents a speed or velocity of a vehicle in kilometers per hour (kph), and the horizontal axis represents time, in arbitrary units; for example, the values “0” to “1000” can represent seconds or fractions of sections depending on the nature of the vehicle. A plurality of lines denoted V_CURR_kph, V_MIN, V_MAX, and V_CCSP are graphed against the axes and represent, respectively, a current velocity of the vehicle, a minimum velocity, a maximum velocity, and a cruise control set point (CCSP) if conventional cruise control is or had been engaged.

FIG. 3 illustrates an example of operating a vehicle in three stages 304, 306, 308. In the first stage 304, conventional target-based control is activated based on a first target speed of 40 kph, followed by a change to a second target speed of about 110 kph. With conventional control setting these points results in rapid changes in the acceleration of the vehicle, as seen by steeply climbing segments of the line V_CURR_kph. In these periods, a human operator may experience sudden, uncomfortable body movement at certain times as acceleration occurs and ends. However, with an embodiment, in the second stage 306, a decline in V_CURR_kph toward V_MIN causes the process of FIG. 2 to respond by urging the actuator closer to V_CCSP. Conversely, as V_CURR_kph reaches or approaches V_MAX, the operation of the process of FIG. 2 moves the actuator closer to V_CCSP. One result is smoother and less disruptive changes in acceleration.

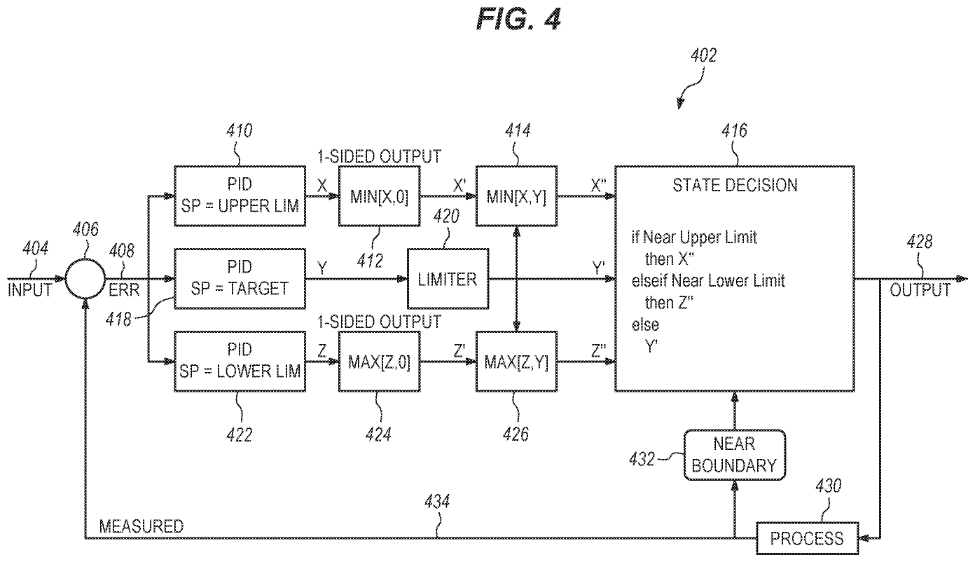

FIG. 4 is a block diagram of circuit logic that could be used to implement one embodiment. In various embodiments, circuit logic 402 of FIG. 4 can comprise a hardware-based vehicle control unit such as an ASIC, FPGA, or microcontroller coupled to programmed firmware, NVRAM, or volatile RAM, any of which can be termed a processor, computer, or controller. In the example of FIG. 4, circuit logic 402 receives a value of an actuator as input 404 at a comparator 406. The input value can be a speed value or other setting of a torque controller, motor controller, automatic throttle, controllable throttle, or cruise control system, as examples.

As a system using the logic of FIG. 4 operates, the then-current value of the actuator is measured continuously and supplied as measured input 434 to the comparator 406, which produces an output 408 denoted ERR representing a difference between the input 404 and the measured value 434. The output 408 is coupled to a plurality of PID units 410, 418, 422 having setpoints (SP) respectively set to an upper limit value, a target value, and a lower limit value. Each of the PID units 410, 418, 422 is programmed to calculate an error value as the difference between the setpoint associated with that PID unit and output 408, which serves as a measured process variable, to apply a correction based on proportional, integral, and derivative terms and supply the corrected process variable value as the output of the PID unit. Thus, PID units 410, 418, 422 respectively produce output values X, Y, Z as seen in FIG. 4.

A first PID unit 410 outputs a value X to a first one-sided output unit 412, which computes the function MIN(X,0) and outputs X′ as a result to MIN unit 414. The MIN unit 414 computes MIN(X,Y) and outputs a result X″ to state decision logic 416. A second PID unit 418 receives the output 408 and produces the value Y, which is supplied to a limiter 420, producing Y′ as a further input to the state decision logic 416. A third PID unit 422 outputs the value Z to a second one-sided output unit 424, which computes the function MAX(Z,0) and produces the output value Z′ to MAX unit 426. The MAX unit 426 computes MAX(Z,Y), producing Z″ as a further input to the state decision logic 416.

Limiter 420 implements a limitation on state choice based on two modes of operation. In a central control mode, which controls the actuator based on a high central authority, the limiter 420 calculates its output value Y′=MAX (MIN (Y, Y_MAX), Y_MIN). In a bounded free coast mode, the limiter 420 calculates its output value Y′=MAX (MIN (Y, YX), YN), where each of YX, YN approximates “0”.

State decision logic 416 is programmed or configured to receive the inputs X″, Y′, and Z″, as well as a near boundary input 432 that specifies whether the ERR value 408 is then currently near one of the boundaries or limits. State decision logic 416 is programmed or configured to output one of the three values based upon the following decision logic. If the near boundary input 432 specifies that the current value is near the upper limit, then state decision logic 416 outputs X″ as its output 428. If the near boundary input 432 specifies that the current value is near the lower limit, then state decision logic 416 outputs Z″ as its output 428. Otherwise, the state decision logic 416 outputs Y′ as its output 428.

The output 428 is coupled to the actuator, as indicated by the arrow leading from output 428 off the sheet, and also to a processing unit 430, which is configured or programmed to determine whether to signal the near boundary input 432 that the output value is near a boundary, and also configured or programmed to provide the output 428 as the next measured value 434. In this manner, output 428 feeds a continuous feedback look by which the output is can be measured and adjusted continuously.

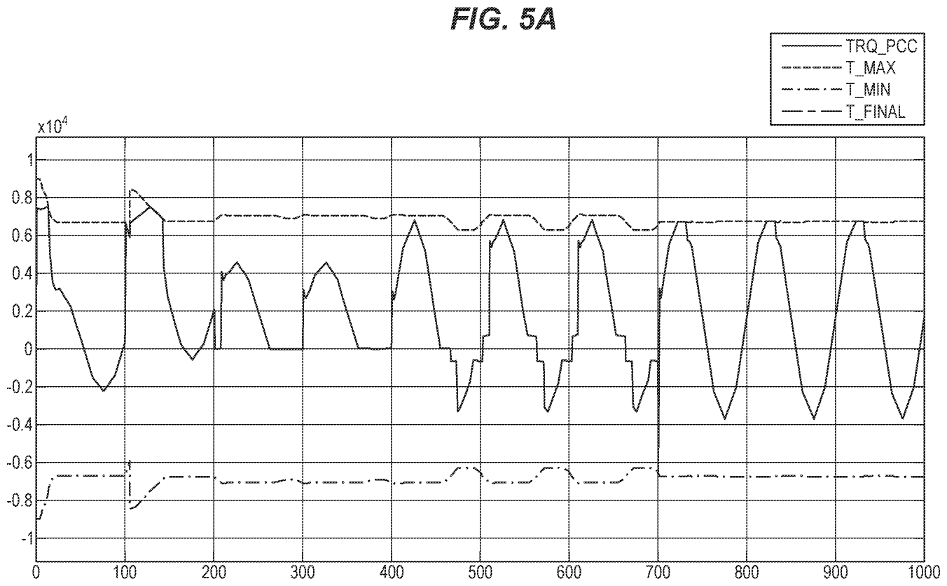

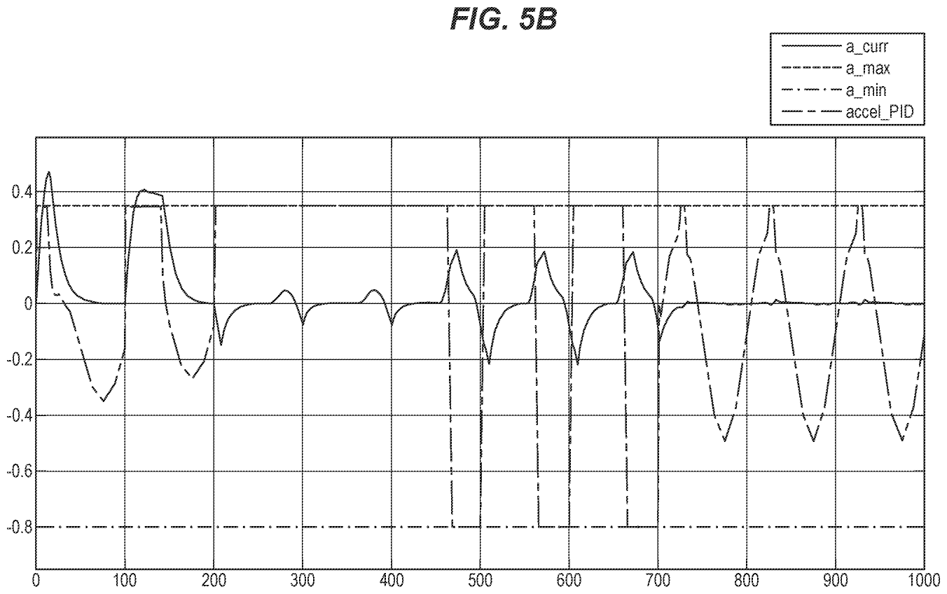

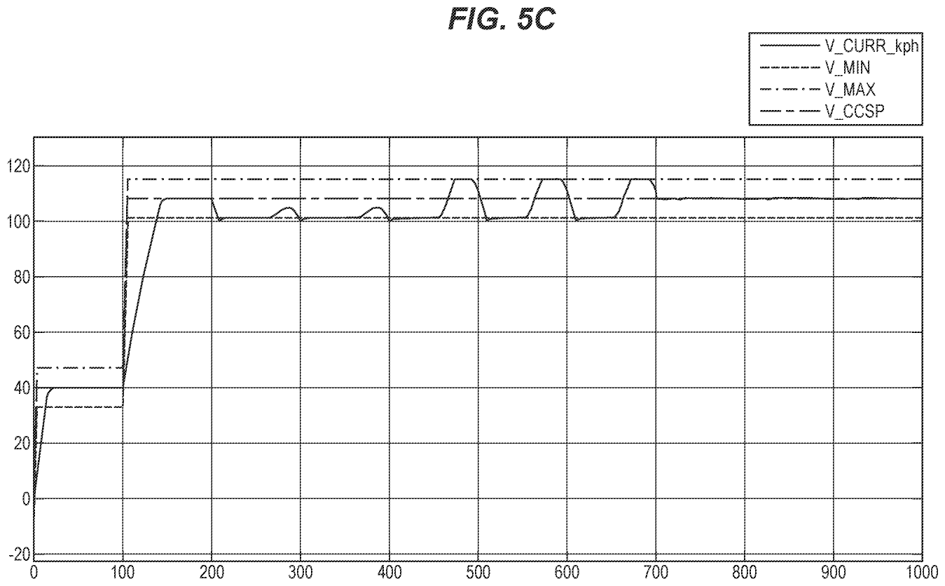

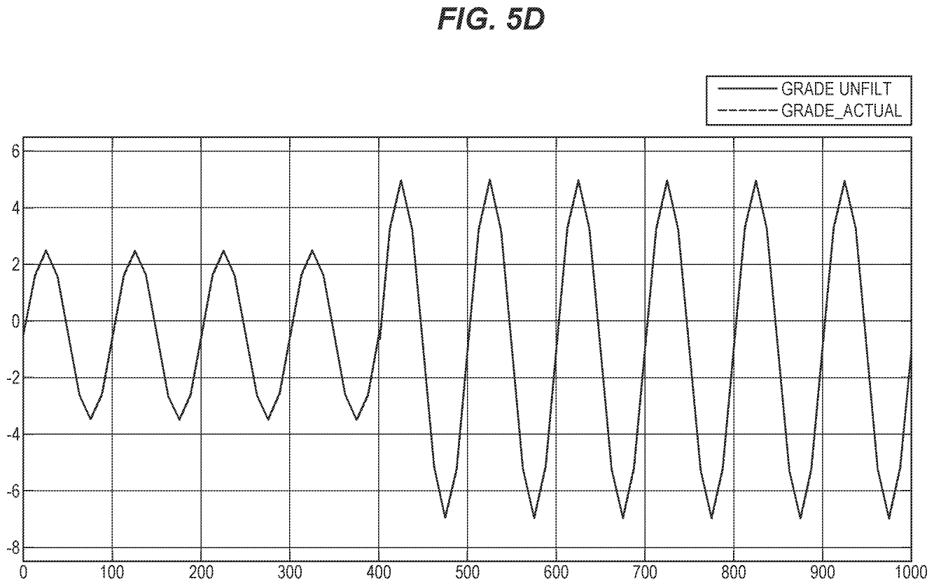

FIG. 5A, FIG. 5B, FIG. 5C. FIG. 5D are line graphs illustrating values of different operating parameters, plotted against time, for a trip of a vehicle in which the techniques of FIG. 2, FIG. 4 have been implemented. FIG. 5A, FIG. 5B, FIG. 5C. FIG. 5D are intended to reflect the same vehicle and the same period of operation, but graph different parameters, so they are best understood together. FIG. 5A is a graph showing an example change in vehicle drivetrain torque over time in a vehicle that is controlled using an embodiment. Units of the vertical axis correspond to torque magnitude above and below a central zero magnitude level and the horizontal axis plots time. FIG. 5A shows the minimum and maximum torque boundary values T_MIN, T_MAX plotted against time; in the example of FIG. 5A, these minimum and maximum values remain relatively flat while actual torque TRQ_PCC varies up and down as a system implementing FIG. 2 or FIG. 4 executes adjustment to motor torque during the travel of a vehicle, based upon continuous measurement of velocity, grade, or other factors.

FIG. 5B is a graph showing an example change in vehicle acceleration over time in a vehicle that is controlled using an embodiment. FIG. 5B uses the same time scale and reflects the same period of operating the same vehicle as in FIG. 5A. Importantly, FIG. 5B plots the magnitude of acceleration a_curr resulting from using an implementation of FIG. 2. FIG. 4 in comparison to the magnitude of acceleration accel_PID that a vehicle would experience using a conventional PID approach. Maximum acceleration and minimum acceleration are denoted a_max and a_min respectively and like FIG. 5A, the graph shows a “0” reference level. It will be seen that the general magnitude of acceleration a_curr is less than accel_PID and at some points substantially less. Thus, a specific physical benefit of the technology of this disclosure is less acceleration to achieve the same goal of a particular speed or velocity near a setpoint.

FIG. 5C is a graph showing an example change in vehicle velocity over time in a vehicle having velocity controlled using an embodiment. FIG. 5C uses the same time scale and reflects the same period of operating the same vehicle as in FIG. 5A. FIG. 5C reflects two distinct hypothetical operating periods. In the first period between t=0 and t=100, the setpoint is about “40” and TGT control is engaged so that velocity increases rapidly from “0” to “40” and then holds at “40” until t=100. Assume the operator then changes the setpoint to about “110”. Velocity again increases rapidly from t=100 to t=200, at which point the operator engages the operation of a control that implements FIG. 2 or FIG. 4. In response, the current velocity V_CURR_kph declines from about t=200 to about t=205 at which point V_CURR_kph reaches V_MIN and the system corrects and/or maintains the current velocity at or near V_MIN. At about t=275, V_CURR_kph increases, perhaps because the vehicle is descending a grade; if the rate of increase of velocity is high enough, then the system urges the actuator down, causing V_CURR_kph to decline again to near V_MIN. This effect repeats at about t=375.

At about t=450, V_CURR_kph rises to V_MAX, again possibly due to descending a grade. Depending on the rate of change of V_CURR_kph and/or the current value of V_CURR_kph, the system may pressure the actuator to maintain the velocity at V_MAX or pressure the actuator to reduce velocity, resulting in a downward curve at t=500.

FIG. 5D is a graph showing an example change in road grade over time for the same vehicle as illustrated in FIG. 5A, FIG. 5B, FIG. 5C. FIG. 5D uses the same time scale and reflects the same period of operating the same vehicle as in FIG. 5A. FIG. 5D shows a relative magnitude of grades that the vehicle traverses, using arbitrary units that reflect relative elevation or descent compared to a level reference point “0.” A comparison of FIG. 5D to FIG. 5C will show that embodiments of the present disclosure are resilient in the face of significant upgrades or downgrades and promotes moderated velocity and acceleration under changing grade conditions.

In one embodiment, the techniques of FIG. 2, FIG. 4 can be configured or programmed to control a vehicle cooling system to provide predictive cooling. In such an embodiment, the actuator identified in FIG. 2 can refer broadly to one or more of the fan control 116, the pump control 118, a combination, or other elements of a cooling system such as a digital thermometer, thermistor, thermostat or valve. The target setpoint value of FIG. 2 can be a target engine temperature value or a target value for an engine fluid such as air, water, coolant, or oil. The upper bound value and lower bound value can be temperature values in any units of temperature. To implement predictive cooling, the process flow of FIG. 2 operates to read a current temperature value from the actuator, determine if the current value is near or approaching the upper bound value or the lower bound value, and initiate or terminate a cooling operation based on the decision logic of FIG. 2, using any element of the actuator that is appropriate to initiate cooling or terminate cooling. Unlike prior techniques, the logic of blocks 210, 216 enable the flow of FIG. 2 to predict when cooling is needed or not needed, and to initiate or terminate cooling before a true need to do so. Since engine cooling requires time, and also consumes engine power, the predictive approach possible with FIG. 2, FIG. 4 enables more efficient consumption of fuel, charge, or power. Furthermore, the techniques herein may also allow development of an engine with a lower tolerance for high-heat conditions, since cooling will initiate before an immediate need and operate to maintain the engine in a narrower range of temperatures, avoiding a high extreme.

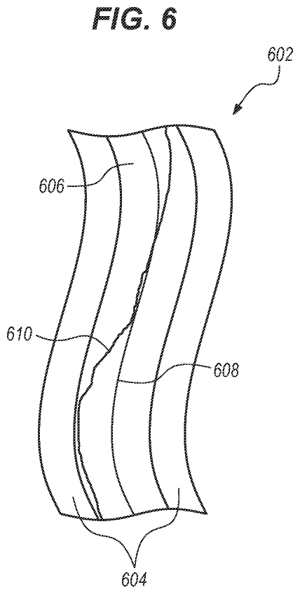

FIG. 6 illustrates a hypothetical road and aspects of vehicle lane control using an embodiment. While some embodiments have been described in relation to controlling motor torque, throttle, and/or velocity or cooling systems of a vehicle, other embodiments can be applied to the control of the lateral lane position of a vehicle. In such an embodiment, the relevant actuator to be sensed and/or biased will be one or more of a steering control, automated steering column, steering rack, rudder, or other elements that control the steering of the vehicle. In some embodiments, the actuator can be a lane keeping assist system or a lane centering assist system that is configured or programmed with an interface capable of accepting instructions or drive signals from a processor executing the flow of FIG. 2 or from the circuit of FIG. 4. The actuator and/or such systems can include video sensors, laser sensors, and/or infrared sensors to detect lane position.

In the example of FIG. 6, a hypothetical road segment 602 is a one-way road and comprises left and right shoulders 604 that are not intended for high-speed or long-term traversal but represent a transition from a paved lane 606 to unpaved areas laterally outward of the lane. Furthermore, shoulders 604 represent positions of maximum deviation from a center line 608, which represents a target setpoint value for a system that implements FIG. 2 or FIG. 4 in the context of lane control. Thus, in the context of lane control, a lateral position of a first shoulder 604 in relation to the center line 608 can represent an upper bound value, and a second lateral position of a second shoulder 604 relative to the center line and opposition the first shoulder can represent the lower bound value.

A traversal line 610 represents an actual center line of traversal of a vehicle, showing deviations from the center line. Having established an upper bound value and a lower bound value based on the shoulders 604 as described above, the flow of FIG. 2 can operate to obtain a real-time current lane position value at block 206. The logic of block 208, 210, 214, 216 can operate to determine whether the real-time current lane position is near a first shoulder or a second shoulder, and whether the rate of approach toward either shoulder is greater than the programmed threshold rate, In response, block 212, 218 can be programmed to signal a steering control, automated steering column, steering rack, rudder, lane keeping assist system or lane centering assist system to initiate corrective steering action to direct the vehicle laterally toward the center line 608 and away from one of the shoulders 604. In the context of FIG. 1, unit 120 can interface to a steering control, automated steering column, steering rack, rudder, lane keeping assist system or lane centering assist system. As described for other embodiments, logic 122 is programmed to transmit signals to the command arbitration unit 124 as a first input, and the command arbitration unit receives a second input from the a steering control, automated steering column, steering rack, rudder, lane keeping assist system or lane centering assist system, the command arbitration unit being programmed to arbitrate the first input and the second unit and to output a steering correction request to adjust a lane position based on arbitrating the first input and the second input. Thus, the process of FIG. 2 or the circuit of FIG. 4 can be used in a vehicle to perform automatic repositioning of the vehicle within a lane if drift occurs too far away from the center line 608 or at too great a rate of drift.

### 3. Implementation Example—Hardware Overview

According to one embodiment, the techniques described herein are implemented by at least one computing device. For example, SRT 102 and/or hybrid control unit 114 can use one or more central processing units, microcontrollers, or other processors that are programmed or hard-wired to perform the techniques, or that include digital electronic devices such as at least one application-specific integrated circuit (ASIC) or field programmable gate array (FPGA) that is persistently programmed to perform the techniques, or that include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques.

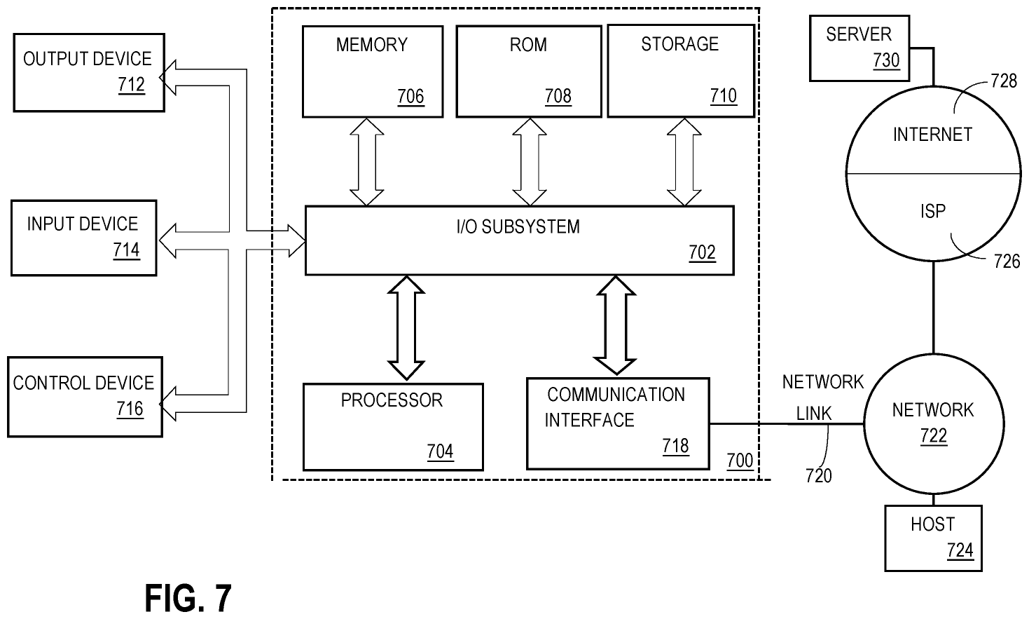

FIG. 7 is a block diagram that illustrates an example computer system with which an embodiment may be implemented. In the example of FIG. 7, a computer system 700 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 700 includes an input/output (I/O) subsystem 702 which may include a bus and/or another communication mechanism(s) for communicating information and/or instructions between the components of the computer system 700 over electronic signal paths. The I/O subsystem 702 may include an I/O controller, a memory controller and at least one I/O port. The electronic signal paths are represented schematically in the drawings, for example as lines, unidirectional arrows, or bidirectional arrows.

At least one hardware processor 704 is coupled to I/O subsystem 702 for processing information and instructions. Hardware processor 704 may include, for example, a general-purpose microprocessor or microcontroller and/or a special-purpose microprocessor such as an embedded system or a graphics processing unit (GPU) or a digital signal processor or ARM processor. Processor 704 may comprise an integrated arithmetic logic unit (ALU) or may be coupled to a separate ALU.

Computer system 700 includes one or more units of memory 706, such as a main memory, which is coupled to I/O subsystem 702 for electronically digitally storing data and instructions to be executed by processor 704. Memory 706 may include volatile memory such as various forms of random-access memory (RAM) or other dynamic storage devices. Memory 706 also may be used for storing temporary variables or other intermediate information during the execution of instructions to be executed by processor 704. Such instructions, when stored in non-transitory computer-readable storage media accessible to processor 704, can render computer system 700 into a special-purpose machine that is customized to perform the operations specified in the instructions.

Computer system 700 further includes non-volatile memory such as read-only memory (ROM) 708 or other static storage devices coupled to I/O subsystem 702 for storing information and instructions for processor 704. The ROM 708 may include various forms of programmable ROM (PROM) such as erasable PROM (EPROM) or electrically erasable PROM (EEPROM). A unit of persistent storage 710 may include various forms of non-volatile RAM (NVRAM), such as FLASH memory, or solid-state storage, magnetic disk or optical disks such as CD-ROM or DVD-ROM and may be coupled to I/O subsystem 702 for storing information and instructions. Storage 710 is an example of a non-transitory computer-readable medium that may be used to store instructions and data which when executed by processor 704 cause performing computer-implemented methods to execute the techniques herein.

The instructions in memory 706, ROM 708, or storage 710 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support I/O, storage, databases, vehicle control, programming or other functions; data protocol instructions or stacks to implement TCP/IP. HTTP or other communication protocols; file format processing instructions to parse or render files coded using parameterized HTML, XML, or other protocols; presentation instructions to transmit commands to another computer for a graphical user interface (GUI), command-line interface or text user interface. The instructions may implement a network stack or web client.

Computer system 700 may be coupled via I/O subsystem 702 to at least one output device 712. In one embodiment, output device 712 is a digital computer display. Examples of a display that may be used in various embodiments include a touchscreen display or a light-emitting diode (LED) display or a liquid crystal display (LCD) or an e-paper display. Computer system 700 may include other type(s) of output devices 712, alternatively or in addition to a display device. Examples of other output devices 712 include printers, sound devices such as horns, speakers, buzzers or piezoelectric devices or other audible devices, lamps or LED or LCD indicators, haptic devices, electromechanical controls, actuators, or servos.

At least one input device 714 is coupled to I/O subsystem 702 for communicating signals, data, command selections, or gestures to processor 704. Examples of input devices 714 include touch screens, microphones, still and video digital cameras, alphanumeric and other keys, keypads, keyboards, joysticks, clocks, switches, rotary encoders, buttons, dials, sliders, and/or various types of sensors such as velocity sensors, speed sensors, force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 716, which may perform cursor control or other automated control functions such as navigation in a graphical interface on a display screen, alternatively or in addition to input functions. The control device 716 may be a touchpad, a mouse, a trackball, or cursor direction keys for communicating direction information and command selections to processor 704 and for controlling cursor movement on display 712. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 714 may include a combination of multiple different input devices, such as a video camera and a depth sensor.

In another embodiment, computer system 700 may comprise an internet of things (IoT) device in which one or more of the output device 712, input device 714, and control device 716 are omitted. Or, in such an embodiment, the input device 714 may comprise one or more cameras, motion detectors, thermometers, microphones, seismic detectors, other sensors or detectors, measurement devices or encoders, and the output device 712 may comprise a special-purpose display such as a single-line LED or LCD display, one or more indicators, a display panel, a meter, a valve, a solenoid, an actuator or a servo.

When computer system 700 is a mobile computing device, input device 714 may comprise a global positioning system (GPS) receiver coupled to a GPS module that is capable of triangulating to a plurality of GPS satellites, determining and generating geo-location or position data such as latitude-longitude values for a geophysical location of the computer system 700. Output device 712 may include hardware, software, firmware, and interfaces for generating position reporting packets, notifications, pulse or heartbeat signals, or other recurring data transmissions that specify a position of the computer system 700, alone or in combination with other application-specific data, directed toward host 724 or server 730.

Computer system 700 may implement the techniques described herein using stored program instructions which when loaded and used or executed in combination with the computer system cause or program the computer system to operate as a special-purpose machine. According to one embodiment, the techniques herein are performed by computer system 700 in response to processor 704 executing one or more sequences of instructions contained in main memory 706. Such instructions may be read into main memory 706 from another storage medium, such as storage 710. Execution of the sequences of instructions contained in main memory 706 causes processor 704 to perform the process steps described herein. In alternative embodiments, hard-wired circuitry may be used in place of or in combination with software instructions.

Thus, in various embodiments the computer system 700 may comprise one or more non-transitory computer-readable storage media storing one or more sequences of instructions which, when executed using one or more processors such as processor 704, cause the one or more processors such as processor 704 to perform the functions that are described herein in the flow diagrams, data flow diagrams, and/or circuit diagrams. The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 710. Volatile media includes dynamic memory, such as memory 706. Common forms of storage media include, for example, a hard disk, solid state drive, flash drive, magnetic data storage medium, any optical or physical data storage medium, memory chip, or the like.

Various forms of media may be involved in carrying at least one sequence of at least one instruction to processor 704 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 700 can receive the data on the communication link and convert the data to a format that can be read by computer system 700. For instance, a receiver such as a radio frequency antenna or an infrared detector can receive the data carried in a wireless or optical signal and appropriate circuitry can provide the data to I/O subsystem 702 such as placing the data on a bus. I/O subsystem 702 carries the data to memory 706, from which processor 704 retrieves and executes the instructions. The instructions received by memory 706 may optionally be stored on storage 710 either before or after execution by processor 704.

Computer system 700 also includes a communication interface 718 coupled to bus 702. Communication interface 718 provides a two-way data communication coupling to network link(s) 720 that are directly or indirectly connected to at least one communication network, such as a network 722 or a public or private cloud on the Internet. For example, communication interface 718 may be an Ethernet networking interface using wireless networking technology, a satellite modem, or a cellular modem to provide a data communication connection to a corresponding type of wireless communications link. Network 722 broadly represents a local area network (LAN), wide-area network (WAN), campus network, internetwork, or any combination thereof. Communication interface 718 may comprise a LAN card to provide a data communication connection to a compatible wireless LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 718 sends and receives electrical, electromagnetic or optical signals over signal paths that carry digital data streams representing various types of information. Network link 720 typically provides electrical, electromagnetic, or optical data communication directly or through at least one network to other data devices, using, for example, satellite, cellular, Wi-Fi, or BLUETOOTH technology. For example, network link 720 may provide a connection through network 722 to a host computer 724.

Furthermore, network link 720 may provide a connection through network 722 or to other computing devices via internetworking devices and/or computers that are operated by an Internet Service Provider (ISP) 726. ISP 726 provides data communication services through a worldwide packet data communication network represented as internet 728. A server computer 730 may be coupled to internet 728. Server 730 broadly represents any computer, data center, virtual machine, or virtual computing instance with or without a hypervisor or computer executing a containerized program system such as DOCKER or KUBERNETES. Server 730 may represent an electronic digital service that is implemented using more than one computer or instance and that is accessed and used by transmitting web services requests, uniform resource locator (URL) strings with parameters in HTTP payloads, API calls, app services calls, or other service calls. Computer system 700 and server 730 may form elements of a distributed computing system that includes other computers, a processing cluster, a server farm, or other organizations of computers that cooperate to perform tasks or execute applications or services. Server 730 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 730 may comprise a web application server that hosts a presentation layer, application layer and data storage layer such as a relational database system using structured query language (SQL) or no SQL, an object store, a graph database, a flat file system or other data storage.

Computer system 700 can send messages and receive data and instructions, including program code, through the network(s), network link 720, and communication interface 718. In the Internet example, server 730 might transmit a requested code for an application program through Internet 728, ISP 726, local network 722, and communication interface 718. The received code may be executed by processor 704 as it is received, and/or stored in storage 710, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 704. While each processor 704 or core of the processor executes a single task at a time, computer system 700 may be programmed to implement multitasking to allow each processor to switch between tasks that are being executed without having to wait for each task to finish. In an embodiment, switches may be performed when tasks perform input/output operations when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method executed using a computer that is communicatively coupled to an actuator, the method comprising:
obtaining, from electronic memory coupled to the computer, a target setpoint value, upper bound value, lower bound value, and proximity value;
continuously measuring, using the actuator, a current value of a metric associated with the actuator;
in response to determining, based on the proximity value, that the current value is near the upper bound value or that a rate of approach of the current value to the upper bound value is greater than an approach threshold, signaling the actuator to cause a reduction of the metric; and
in response to determining, based on the proximity value, that the current value is near the lower bound value or that a rate of approach of the current value to the lower bound value is greater than an approach threshold, signaling the actuator to cause an increase in the metric.

2. The computer-implemented method of claim 1, wherein the actuator is a unit of an electromechanical system, the method further comprising repeating the continuously measuring, the determining, and the signaling in real-time as the electromechanical system operates.

3. The computer-implemented method of claim 1, wherein the computer is in a motor-driven land vehicle.

4. The computer-implemented method of claim 1, wherein the target setpoint value, the upper bound value, and the lower bound value comprise vehicle speed values.

5. The computer-implemented method of claim 1, wherein the actuator is a throttle of a land vehicle.

6. The computer-implemented method of claim 1, wherein the actuator is a motor controller of a land vehicle.

7. The computer-implemented method of claim 1, wherein the actuator is a torque controller of a land vehicle.

8. The computer-implemented method of claim 1, wherein each of the signaling operations comprises transmitting a signal to a command arbitration unit as a first input to the command arbitration unit, wherein the command arbitration unit comprises a second input that is coupled to a cruise control sensing and status setpoint unit, the command arbitration unit being programmed to arbitrate the first input and the second unit and to output a torque request based on arbitrating the first input and the second input.

9. The computer-implemented method of claim 1, wherein each of the signaling operations comprises transmitting a signal to a command arbitration unit as a first input to the command arbitration unit, wherein the command arbitration unit comprises a second input that is coupled to a steering control, automated steering column, steering rack, rudder, lane keeping assist system or lane centering assist system, the command arbitration unit being programmed to arbitrate the first input and the second unit and to output a steering correction request to adjust a lane position based on arbitrating the first input and the second input.

10. The computer-implemented method of claim 1, wherein each of the signaling operations comprises transmitting a signal to a command arbitration unit as a first input to the command arbitration unit, wherein the command arbitration unit comprises a second input that is coupled to a fan control, pump control, a digital thermometer, thermistor, thermostat or valve, the command arbitration unit being programmed to arbitrate the first input and the second unit and to output a cooling request to one or more of the fan control, pump control, a digital thermometer, thermistor, thermostat or valve, based on arbitrating the first input and the second input.

11. The computer-implemented method of claim 1, further comprising additionally executing a closed-loop PID control to maintain the target setpoint value via periodic actuation of the actuator and continuous measurement of a response of the actuator.

12. A hardware-based vehicle control unit comprising one or more of firmware, NVRAM, or volatile RAM storing one or more sequences of instructions which, when executed using the hardware-based vehicle control unit, causes the hardware-based vehicle control unit to execute:
obtaining, from electronic memory coupled to the vehicle control unit, a target setpoint value, upper bound value, lower bound value, and proximity value;
continuously measuring, using the actuator, a current value of a metric associated with the actuator;
in response to determining, based on the proximity value, that the current value is near the upper bound value or that a rate of approach of the current value to the upper bound value is greater than an approach threshold, signaling the actuator to cause a reduction of the metric; and
in response to determining, based on the proximity value, that the current value is near the lower bound value or that a rate of approach of the current value to the lower bound value is greater than an approach threshold, signaling the actuator to cause an increase in the metric.

13. The vehicle control unit of claim 12, wherein the actuator is a unit of an electromechanical system, the vehicle control unit being further programmed to execute: repeating the continuously measuring, the determining, and the signaling in real-time as the electromechanical system operates.

14. The vehicle control unit of claim 12, in a motor-driven land vehicle.

15. The vehicle control unit of claim 12, wherein the target setpoint value, upper bound value, and the lower bound value comprise vehicle speed values.

16. The vehicle control unit of claim 12, wherein the actuator is a throttle of a land vehicle.

17. The vehicle control unit of claim 12, wherein the actuator is a motor controller of a land vehicle.

18. The vehicle control unit of claim 12, wherein the actuator is a torque controller of a land vehicle.

19. The vehicle control unit of claim 12, wherein each of the signaling operations comprises transmitting a signal to a command arbitration unit as a first input to the command arbitration unit, wherein the command arbitration unit comprises a second input that is coupled to a cruise control sensing and status setpoint unit, the command arbitration unit being programmed to arbitrate the first input and the second unit and to output a torque request based on arbitrating the first input and the second input.

20. The vehicle control unit of claim 12, wherein each of the signaling operations comprises transmitting a signal to a command arbitration unit as a first input to the command arbitration unit, wherein the command arbitration unit comprises a second input that is coupled to a steering control, automated steering column, steering rack, rudder, lane keeping assist system or lane centering assist system, the command arbitration unit being programmed to arbitrate the first input and the second unit and to output a steering correction request to adjust a lane position based on arbitrating the first input and the second input.

21. The vehicle control unit of claim 12, wherein each of the signaling operations comprises transmitting a signal to a command arbitration unit as a first input to the command arbitration unit, wherein the command arbitration unit comprises a second input that is coupled to a fan control, pump control, a digital thermometer, thermistor, thermostat or valve, the command arbitration unit being programmed to arbitrate the first input and the second unit and to output a cooling request to one or more of the fan control, pump control, a digital thermometer, thermistor, thermostat or valve, based on arbitrating the first input and the second input.

22. The vehicle control unit of claim 12, the vehicle control unit being further programmed to execute a closed-loop PID control to maintain the target setpoint value via periodic actuation of the actuator and continuous measurement of a response of the actuator.
